(19) United States
(12) Patent Application Publication
(10) Pub. No.: US 2021/0157489 A1
(43) Pub. Date: May 27, 2021

(54) SUPERVISOR MODE ACCESS PROTECTION FOR FAST NETWORKING

(71) Applicant: RED HAT, INC., Raleigh, NC (US)

(72) Inventor: Michael Tsirkin, Lexington, MA (US)

(21) Appl. No.: 16/694,076

(22) Filed: Nov. 25, 2019

(51) Int. Cl. G06F 3/06

(52) U.S. Cl. CPC G06F 3/0622; G06F 3/0679; G06F 3/0647

(57) ABSTRACT

A first processing device executing a supervisor mode manager receives a first notification to monitor a data structure for a request to copy data from an application memory space to an operating system (OS) memory space, wherein the request to copy the data is associated with a second processing device. The supervisor mode manger retrieves an entry from the data structure, wherein the entry comprises a source address associated with the data in the application memory space and a destination address in the OS memory space, copies the data from the source address in the application memory space to the destination address in the OS memory space, and responsive to copying the data from the source address to the destination address, sends a second notification to a third processing device to cause the third processing device to perform an operation on the data at the destination address in the OS memory space.

### TECHNICAL FIELD

The present disclosure is generally related to computer systems, and more particularly, to supervisor mode access protection for fast networking in computer systems.

### BACKGROUND

Computer operating systems typically segregate virtual memory into operating system (OS) memory space (“kernel space”) and application memory space (“user space”). This separation can provide memory protection and hardware protection from malicious or errant software behavior. Kernel space is reserved for running a privileged operating system kernel, kernel extensions, and device drivers. User space is the memory area where application software executes.

Operating modes for a central processing unit (CPU) of many computer systems (typically referred to as “CPU modes”) place restrictions on the type and scope of operations that can be performed by certain processes being executed by the CPU. This can allow the operating system to run with more privileges than application software. Typically, only highly trusted kernel code is allowed to execute in an unrestricted mode (or “supervisor mode”). Other code (including non-supervisory portions of the operating system) executes in a restricted mode and uses a system call (e.g., via an interrupt) to request that the kernel perform a privileged operation on its behalf, thereby preventing untrusted programs from altering protected memory (e.g., other programs or the computing system itself). Code operating in supervisor mode can access both kernel space and user space, while code operating in restricted mode can typically only access user space.

### BRIEF DESCRIPTION OF THE DRAWINGS

The present disclosure is illustrated by way of example, and not by way of limitation, and can be more fully understood with reference to the following detailed description when considered in connection with the figures in which:

FIG. 1 depicts a high-level component diagram of an example computer system architecture, in accordance with one or more aspects of the present disclosure.

FIG. 2 depicts a block diagram illustrating an example of a supervisor mode manager to facilitate SMAP protection for fast networking, in accordance with one or more aspects of the present disclosure.

FIG. 3 depicts a flow diagram of a method for facilitating supervisor mode access protection for fast networking, in accordance with one or more aspects of the present disclosure.

FIG. 4 depicts a flow diagram of a method for managing supervisor mode access protection for fast networking, in accordance with one or more aspects of the present disclosure.

FIG. 5 depicts a block diagram of an illustrative computer system operating in accordance with one or more aspects of the present disclosure.

### DETAILED DESCRIPTION

Described herein are methods and systems for supervisor mode access protection for fast networking in computer systems. In supervisor mode, a CPU may perform any operation allowed by its architecture (e.g., any instruction may be executed, any I/O operation initiated, any area of memory accessed, etc.). Supervisor Mode Access Prevention (SMAP) is a feature of some CPU implementations that allows supervisor mode programs to optionally set user space memory mappings so that access to those mappings from supervisor mode will fail. Without SMAP enabled, a supervisor mode program usually has full read and write access to user space memory mappings (or has the ability to obtain full access). This can result in security exploits (e.g., including privilege escalation exploits) which operate by causing the kernel to access user space memory when it did not intend to. Operating systems can block these exploits by using SMAP to force unintended user space memory accesses to trigger page faults. Additionally, SMAP can expose flawed kernel code which does not follow the intended procedures for accessing user-space memory. This can make it more difficult for malicious programs to cause the kernel to execute instructions or access data in user space.

Enabling SMAP, however, can present significant challenges to systems with a high volume of interaction with user space memory. In particular, the use of SMAP for interacting with user space memory as a result of networking communications can result in significant overhead since SMAP should be temporarily disabled any time supervisor code intends to access user space memory. For example, SMAP should be disabled when supervisor code is invoked to copy a networking packet from user space to kernel space in order to forward that packet to a networking device. Additionally, the use of SMAP in an operating system may lead to a larger kernel size, which can significantly increase the computing resources needed to execute the kernel, and at the same time reducing the overall performance of a system.

Conventional systems typically manage SMAP implementations by minimizing the amount of time that SMAP is actually enabled for a CPU executing supervisor code. For example, when an application program performs a networking operation (e.g., executes a request to send a networking packet) the CPU can enable SMAP, copy the packet from user space to kernel space, perform the networking operation, then disable SMAP. These implementations, however, still present performance issues since one CPU is enabling and disabling SMAP to process a single user space access operation. When implemented in systems involving large amounts of networking traffic, performance can still be significantly degraded. Additionally, these types of implementations can still present security risk since user space memory may be exposed to supervisor code longer than needed to complete a copy operation from user space to kernel space. In other implementations, SMAP is disabled entirely, thereby eliminating security benefits of its protection in favor of increased performance.

Aspects of the present disclosure address the above noted and other deficiencies by implementing a supervisor mode manager (e.g., as a computer program or a computer program component) to facilitate supervisor mode access protection for fast networking in computer systems. The supervisor mode manager can assign a single CPU to monitor a data structure that stores requests to copy data from application memory space (user space) to kernel memory space. That CPU can enable access to user space (by disabling SMAP), access the data structure to retrieve a request, and perform the copy of the data from user space to kernel space. Once the copy operation is performed, the monitoring CPU can notify another CPU to process the copied data (e.g., perform a networking operation on a networking data packet). The monitoring CPU can then check the data structure for additional requests to copy data from user space to kernel space while SMAP remains disabled.

Aspects of the present disclosure present advantages over conventional solutions to the issues noted above. First, the supervisor mode manager can designate a single CPU for performing data copy operations between user space and kernel space. Thus, system overhead can be significantly reduced since SMAP would not be disabled and re-enabled for each copy. Additionally, since overhead is reduced, performance (particularly during periods of high volume) can be dramatically improved.

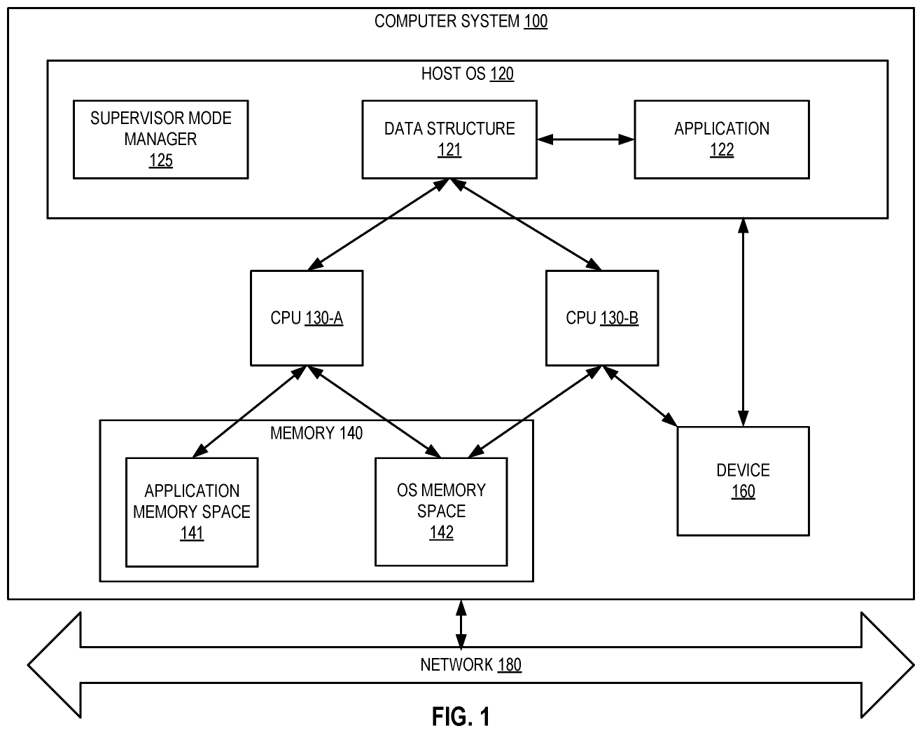

FIG. 1 is a block diagram of a computer system 100 in which implementations of the disclosure may operate. Although implementations of the disclosure are described in accordance with a certain type of system, this should not be considered as limiting the scope or usefulness of the features of the disclosure.

As shown in FIG. 1, the computer system 100 is connected to a network 180 and comprises one or more central processing units (CPU) 130-A, 130-B, memory 140, and one or more devices 160 (e.g., a Peripheral Component Interconnect [PCI] device, network interface controller (NIC), a video card, an I/O device, etc.). The computer system 100 may be a server, a mainframe, a workstation, a personal computer (PC), a mobile phone, a palm-sized computing device, etc. The network 180 may be a private network (e.g., a local area network (LAN), a wide area network (WAN), intranet, etc.) or a public network (e.g., the Internet). It should be noted that although, for simplicity, a two CPUs 130-A, 130-B, and a single device 160 are depicted in FIG. 1, other implementations of computer system 100 may comprise a more than two CPUs 130, and more than one device 160.

In some implementations, memory 140 may include volatile memory devices (e.g., random access memory (RAM)), non-volatile memory devices (e.g., flash memory) and/or other types of memory devices. Memory 140 may be non-uniform access (NUMA), such that memory access time depends on the memory location relative to CPUs 130-A, 130-B. As shown in FIG. 1, memory 140 can be configured to include application memory space 141 (e.g., user space) and operating system (OS) memory space 142 (e.g., kernel space). Application memory space 141 is the memory area associated with application programs (e.g., application 122). OS memory space 142 is reserved for running privileged functions and device drivers for host OS 120.

Computer system 100 may also include a host operating system (OS) 120, which may comprise software, hardware, or both, that manages the resources of the computer system and that provides functions such as inter-process communication, scheduling, virtual memory management, and so forth. In some implementations, host OS 120 can also manage one or more application programs 122 that execute within computer system 100. As noted above, application 122 can access application memory space 141 for reading and/or writing of data. In some implementations, application 122 may execute an operation that involves copying data from application memory space 141 (user space) to OS memory space 142 (kernel space) for additional processing. For example, application 122 may execute a command to send a networking packet to a networking device (e.g., device 160). In various implementations, application 122 may be executed by a CPU of computer system 100 that executes with supervisor mode access to application memory space 141 disabled (e.g., SMAP enabled).

In such instances, application 122 may execute a system command that causes host OS 120 (or a component of host OS 120) to write an entry into data structure 121. In various implementations, data structure may be a linked list, a table, or the like. Data structure 121 can include entries associated with requests from one or more applications 122, where each entry corresponds to a request to copy data between application memory space 141 and OS memory space 142. For example, an entry can represent a request from application 122 (or a component or device driver of Host OS 120) to copy data from application memory space 141 to OS memory space 142. Similarly, an entry can represent a request to copy data from OS memory space 142 to application memory space 142. As noted above, applications 122 may be executed by a CPU with supervisor mode access to the application memory space 141 disabled (e.g., SMAP enabled). In such instances, the entries in the data structure would thus be associated with a CPU with supervisor mode access to the memory space 141 disabled (e.g., a CPU with SMAP enabled). In various embodiments, the data structure entry may include a flag, bitmap, or other descriptive information that indicates that supervisor mode access to memory space 141 has been disabled for the CPU associated with the application that generated the request.

In some implementations, an entry in data structure 121 can include a source location of data to be copied and a destination to which to copy the data. For example, an entry can an address of the data to be copied within application memory space 141, and an address within OS memory space that is to receive the copied data. Additionally, in some implementations, the entry in data structure 121 can include information associated with an operation to be performed on the data after the copy operation has completed. For example, the entry can include an address of a function to be performed, a function pointer, or the like.

In an illustrative example, application 122 can execute a command to send a networking packet stored in application memory space 141 to device 160. The system command can cause host OS 120 to write an entry in data structure 121 that includes the location of the packet in application memory space 141, a location in OS memory space 142 (e.g., a kernel buffer), and a function pointer to indicate that a networking function is to be performed once the data has been copied.

Host OS 120 can also include supervisor mode manager 125 to facilitate supervisor mode access protection for fast networking in computer systems. In various implementations, supervisor mode manager 125 can be executed by a dedicated CPU (e.g., CPU 130-A) that monitors data structure 121 for new entries that represent requests to copy data. In one example, supervisor mode manager 125 can be executed by CPU 130-A as long as host OS 120 executes. In such instances, supervisor mode manager 125 can receive a notification to monitor data structure 121 for requests to copy data from application memory space 141 to OS memory space 142. For example, supervisor mode manager 125 can receive a notification that an entry has been added to data structure 121. Alternatively, supervisor mode manager 125 may be invoked by host OS 120 at system start up to cause CPU 130-A to poll data structure 121 for new entries.

In some implementations, where CPU 130-A executes with supervisor mode access to application memory space 141 disabled (e.g., where SMAP is enabled for CPU 130-A), supervisor mode manager 125 can enable access to application memory space 141 for CPU 130-A (e.g., by disabling SMAP for CPU 130-A) for as long as it monitors data structure 121. Alternatively, in some implementations, CPU 130-A may execute with supervisor mode access to application memory space 141 already enabled (e.g., where SMAP is disabled for CPU 130-A at system startup). In such instances, supervisor mode manager 135 can maintain supervisor mode access for CPU 130-A (e.g., by leaving SMAP disabled) for as long as it monitors data structure 121. Supervisor mode manager 125 can then retrieve an entry from the data structure, and copy the data from the source address in application memory 141 to the destination address in OS memory space 142. Responsive to copying the data from application memory space 141 to OS memory space 142, supervisor mode manager 125 can send a notification to CPU 130-B to perform an operation on the data that has been copied to OS memory space 142. In implementations, while CPU 130-A executes with SMAP disabled to complete copy operations, CPU 130-B executes with SMAP enabled. Thus, CPU 130-A has access to application memory space 141 so that it can complete the copy from application memory space 141 to OS memory space 142, but CPU 130-B does not have access to application memory space 141.

In an illustrative example, supervisor mode manager 125 can cause CPU 130-A to send an inter-processor interrupt (IPI) to CPU 130-B to perform the operation on the copied data. As noted above, the entry in data structure 121 can include information associated with the operation to be performed on the data, such as a function pointer. The notification sent to CPU 130-B can cause CPU 130-B to access the entry in the data structure to identify the function pointer (or other information associated with the operation to be performed on the data), and execute the function using the function pointer. Alternatively, the notification sent to CPU 130-B can include the address of the data in OS memory space 142 and the location of the function pointer. In such instances, CPU 130-B can perform the operation on the copied data by executing the function identified by the function pointer without accessing data structure 121. In another example, supervisor mode manager 125 can generate another data structure in OS memory space that is accessible to CPU 130-B that includes the address of the copied data as well as the information that identifies the operation to be performed.

Once the data has been copied by CPU 130-A from application memory space 141 to OS memory space 142, supervisor mode manager 125 can continue monitoring the data structure 121 for additional entries associated with additional requests to copy data from application memory space 141 to OS memory space 142. Once a copy operation has completed, supervisor mode manager 125 causes CPU 130-A to send a notification to CPU 130-B to process the copied data. Supervisor mode manager 125 then resumes monitoring data structure 121 for other requests.

In some implementations, supervisor mode manager 125 may be executed by a CPU 130 that is not permanently dedicated to monitoring the data structure 121. In such instances, both CPU 130-A and 130-B may both be initially configured with SMAP enabled, and data structure 121 may be configured to alert host OS 120 (or a component of host OS 120 such as a scheduler component, an alert handler component, or the like) that a request entry has been written to data structure 121. Subsequently, host OS 120 can select one of CPUs 130-A or 130-B to execute supervisor mode manager 125. Supervisor mode manager 125 can then monitor the data structure 121 as described above by disabling SMAP for the selected CPU and processing any entries retrieved from data structure 121. Responsive to determining that there are no additional entries in data structure 121, supervisor mode manager 125 can then re-enable SMAP for the selected CPU and return control of the selected CPU to the host OS 120 (or a component of host OS 120 such as a scheduler component) to assign the CPU to perform other tasks.

In some implementations, supervisor mode manager 125 may be invoked in view of observed performance measurements of the applications executing within computer system 100. In such instances, both CPU 130-A and 130-B may both be initially configured with SMAP enabled, and performance statistics can be monitored. Responsive to determining that the system performance satisfies a high threshold, supervisor mode manager 125 can select one of CPUs 130-A or 130-B to monitor data structure 121 as described above. For example, if the rate of application requests to copy data from application memory space 141 to OS memory space 142 increases to satisfy a high threshold, supervisor mode manager 125 may assign a CPU 130-A to monitor data structure 121. Supervisor mode manager 125 can disable SMAP for CPU 130-A and monitor data structure for request entries. Once the rate of application requests falls to satisfy a low threshold, supervisor mode manager 125 can re-enable SMAP for CPU 130-A and return control of CPU 130-A to the host OS 120 (or a component of host OS 120 such as a scheduler component) to assign the CPU to perform other tasks.

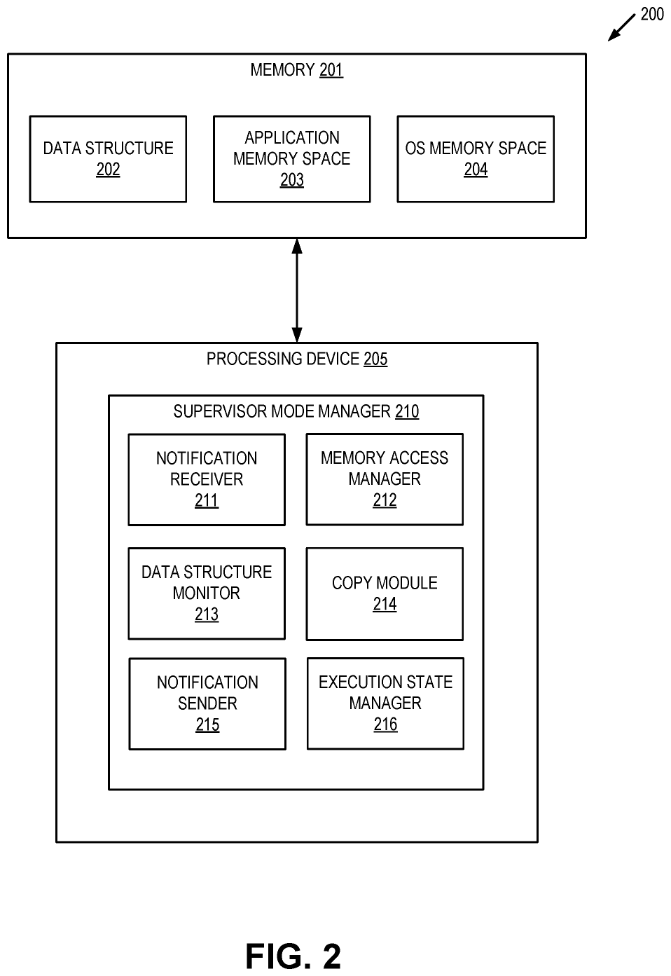

Supervisor mode manager 125 is described in further detail below with respect to FIG. 2.

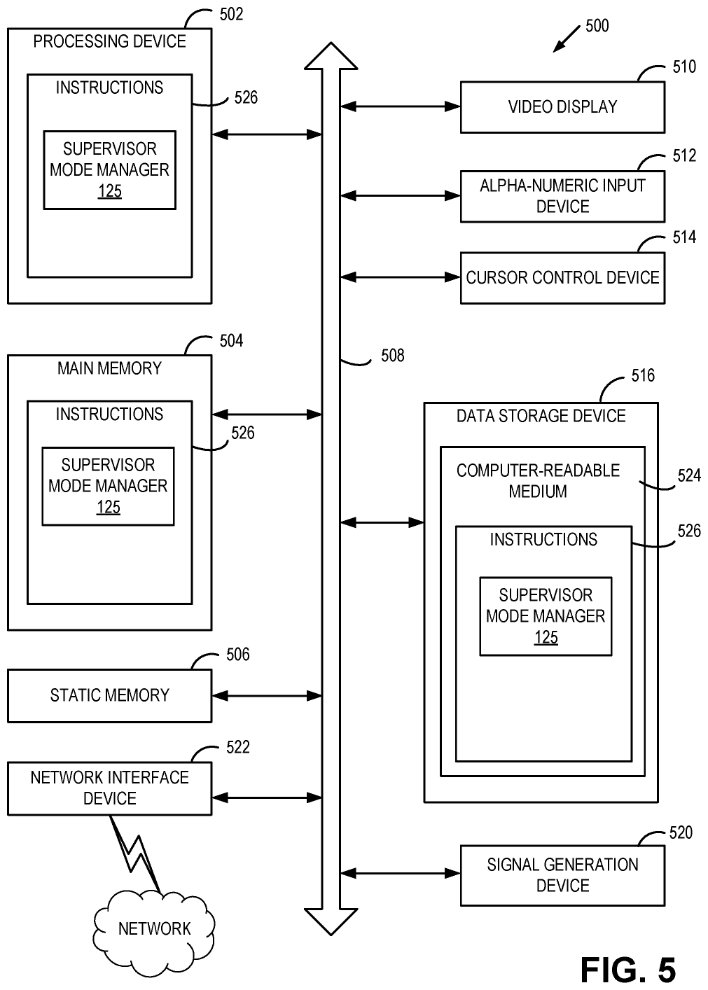

FIG. 2 depicts a block diagram illustrating an example of a supervisor mode manager 210 for facilitating supervisor mode access protection for fast networking in computer systems. In some implementations, supervisor mode manager 210 may correspond to supervisor mode manager 125 of FIG. 1. As shown in FIG. 2, supervisor mode manager 210 may be a component of a computing apparatus 200 that includes a processing device 205, operatively coupled to a memory 201, to execute supervisor mode manager 210. In some implementations, processing device 205 and memory 201 may correspond to processing device 502 and main memory 504 respectively as described below with respect to FIG. 5.

Supervisor mode manager 210 may include notification receiver 211, memory access manager 212, data structure monitor 213, copy module 214, notification sender 215, and execution state manager 216. Alternatively, the functionality of one or more of notification receiver 211, memory access manager 212, data structure monitor 213, copy module 214, notification sender 215, and execution state manager 216 may be combined into a single module or divided into multiple sub-modules.

Notification receiver 211 is responsible for receiving a notification to monitor a data structure (e.g., data structure 202) for requests to copy data from an application memory space 202 (e.g., user space) to OS memory space 204 (e.g., a kernel memory space, a kernel buffer, etc.). In one example, data structure 202 can be configured to generate an interrupt when an entry has been added as a result of a command executed by an application. In such instances, notification receiver 211 can detect the interrupt and begin processing entries in the data structure. In another example, supervisor mode manager 210 can execute a system command that allows it to monitor data structure 202 without consuming power and without causing processing device 205 to enter an idle state. In such instances, when a request entry is added to data structure 202, notification receiver 211 can be notified (e.g., via generation of an interrupt) to resume processing. In another example, notification receiver 211 can detect the execution of a system call that writes a request entry to data structure 202. In another example, notification receiver 211 can detect an interrupt generated by an OS scheduler component based on system performance.

Memory access manager 212 is responsible for managing supervisor mode access to the application memory space 203 by processing device 205. In some implementations, memory access manager 212 can enable supervisor mode access to the application memory space 203 by disabling supervisor mode access prevention (SMAP) for the application memory space. For example, memory access manager 212 can execute (or invoke an interrupt service routine manager to execute) a command to modify a flag in the memory page table entry associated with the application memory space 203 (e.g., a “user space access control” flag) to indicate that the application memory space can be accessed by the processing device 205 (e.g., a “set access control” command). Subsequently, when processing device 205 no longer needs supervisor mode access to the application memory space 203, memory access manager 212 can disable access by enabling SMAP for the application memory space. For example, memory access manager 212 can execute (or invoke an interrupt service routine manager to execute) a command to modify the flag in the memory page table entry associated with the application memory space 203 (e.g., the “user space access control” flag) to indicate that the application memory space 203 can no longer be accessed by the processing device 205 (e.g., a “clear access control” command).

In some implementations, as noted above with respect to FIG. 1, memory access manager 212 may be invoked at system startup for processing device 205 to enable supervisor mode access to application memory space 203 (e.g., disabling SMAP for processing device 205 at system startup). In such instances, memory access manager 212 can maintain supervisor mode access to application memory space 203 for processing device 205 (e.g., by leaving SMAP disabled) for as long as data structure 202 is monitored. Alternatively, in implementations where processing device 205 initially executes with supervisor mode access to application memory space 203 disabled (e.g., when SMAP is enabled for processing device 205), memory access manager 212 may be invoked by notification receiver 211 to enable supervisor mode access to application memory space 203 (e.g., by disabling SMAP for processing device 205).

Data structure monitor 213 is responsible for retrieving an entry from data structure 202. As noted above, in various implementations, each entry in data structure 202 can include information associated with a request to copy data from application memory space 203 to OS memory space 204 (or from OS memory space 204 to application memory space 203). For example, a request entry can include a source address location associated with data in application memory space 203 to be copied as well as a destination location address in OS memory space 204 to which to copy the data. Additionally, in some implementations, the request entry may include information associated with an operation to be performed on the data once it has been copied. This additional information can include a function address (e.g., a function pointer) associated with the operation to be performed by a second processing device (e.g., a processing device other than processing device 205).

Copy module 214 is responsible for copying the data from the source address in application memory space 203 to the destination address in OS memory space 204. Once the copy has completed, copy module 214 can invoke notification sender 215.

Notification sender 215 is responsible for sending a notification to another processing device (e.g., a processing device other than processing device 205) to perform the operation on the copied data (e.g., the operation identified in the request entry retrieved from data structure 202). In some implementations, the notification send by notification sender 215 can be an inter-processor interrupt (IPI) to the other processing device. Alternatively, notification sender 215 can send a notification to a scheduler component of the host OS to select an idle processing device to execute the operation on the copied data.

In some implementations, the notification sent by notification sender 215 can include a reference to the entry in data structure 202. The selected additional processing device can then access the entry in data structure 202 to determine the destination address location in OS memory space 204 of the copied data as well as the information associated with the operation to be performed.

Alternatively, in some implementations, the information associated with the operation to be performed on the copied data can be stored in a separate data structure (e.g., a separate table, linked list, etc.). In such instances, notification sender 215 can create an entry in the separate data structure that includes the destination address of the copied data and the information associated with the operation to be performed. Notification sender 215 can then send information associated with this entry (e.g., an address) to the other processing device to perform the operation. Alternatively, notification sender 215 can send an IPI to the second processing device to indicate that there is an entry in the separate data structure to be processed.

Once the notification has been sent to the additional processing device, notification sender 215 can return control to data structure monitor 215 to continue to monitor data structure 202 for additional requests to copy data from application memory space 203 to OS memory space 204. The above process can be repeated for each additional request entry retrieved from data structure 202. As noted above, in some implementations, processing device 205 can be dedicated to persistent monitoring of data structure 202. In such instances, responsive to determining that no additional request entries are present in data structure 202, data structure monitor 213 can invoke execution state manager 216 to update the execution state of processing device 205 to indicate that it is in a low power state. As noted above, this can allow processing device 205 to monitor data structure 202 without consuming power and without entering an idle state to prevent processing device 205 from being reassigned to other tasks by a scheduler component of the host OS while SMAP is disabled.

In some implementations, processing device 205 may not be dedicated to persistent monitoring of data structure 202. In one example, supervisor mode manager 210 may be invoked when there are entries added to data structure 202. In such instances, responsive to determining that no additional request entries are present in data structure 202, data structure monitor 213 can terminate monitoring of data structure 202 and invoke memory access manager 212 to re-enable SMAP for processing device 205. With SMAP re-enabled, execution state manager 216 can be invoked to update the execution state of processing device 205 to indicate that it is in an idle state to allow processing device 205 to be assigned to other tasks.

In another example, supervisor mode manager 210 may be invoked when a performance threshold has been reached. For example, if the rate of application requests to copy data from application memory space 203 to OS memory space 204 satisfies a high threshold rate (e.g., during periods of high network traffic requests), supervisor mode manager 210 may be invoked to temporarily assign a dedicated processing device to monitor data structure 202. In such instances, processing device 205 can continue processing entries from data structure 202 as described above until the rate of application requests falls to satisfy a low threshold rate. Responsive to determining that the low threshold rate has been satisfied, data structure monitor 213 can terminate monitoring of data structure 202 and invoke memory access manager 212 to re-enable SMAP for processing device 205. With SMAP re-enabled, execution state manager 216 can be invoked to update the execution state of processing device 205 to indicate that it is in an idle state to allow processing device 205 to be assigned to other tasks.

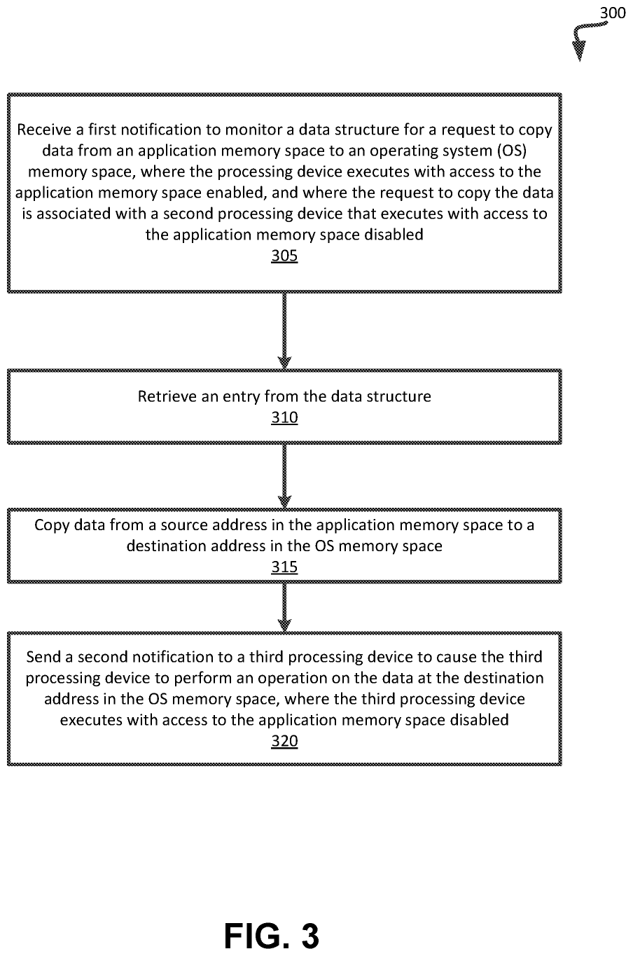

FIG. 3 depicts a flow diagram of an example method 300 for facilitating supervisor mode access protection for fast networking in a computer system. The method may be performed by processing logic that may comprise hardware (circuitry, dedicated logic, etc.), computer readable instructions (run on a general purpose computer system or a dedicated machine), or a combination of both. In an illustrative example, method 300 may be performed by supervisor mode manager 125 in FIG. 1, or supervisor mode manager 210 in FIG. 2. Alternatively, some or all of method 300 might be performed by another module or machine. It should be noted that blocks depicted in FIG. 3 could be performed simultaneously or in a different order than that depicted.

At block 305, processing logic receives a first notification to monitor a data structure for a request to copy data from an application memory space to an operating system (OS) memory space. In various implementations, the processing logic can execute with access to the application memory space enabled and the request to copy the data can be associated with a second processing device that executes with access to the application memory space disabled. In some implementations, access to the memory space can be enabled by disabling SMAP for the processing device. Similarly, access to the memory space can be disabled by enabling SMAP for the processing device. At block 315, processing logic retrieves an entry from the data structure, where the entry includes a source address associated with the data in the application memory space and a destination address in the OS memory space. At block 320, processing logic copies the data from the source address in the application memory space to the destination address in the OS memory space. At block 325, processing logic sends a second notification to a third processing device to cause the third processing device to perform an operation on the data at the destination address in the OS memory space, where the third processing device executes with access to the application memory space disabled.

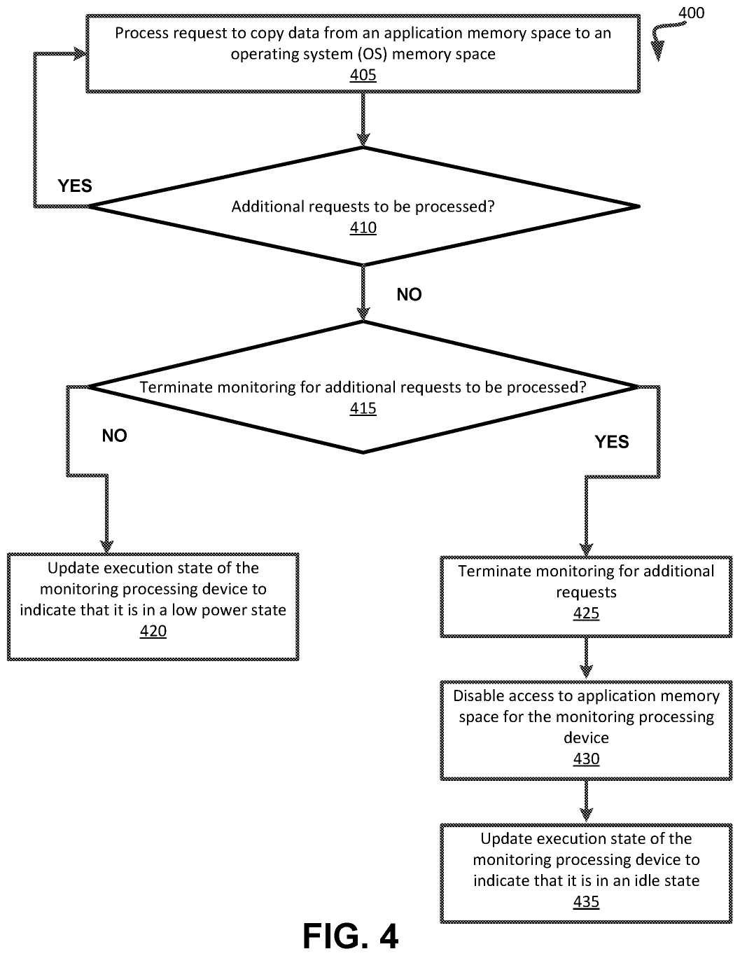

FIG. 4 depicts a flow diagram of an example method 400 for managing supervisor mode access protection for fast networking. The method may be performed by processing logic that may comprise hardware (circuitry, dedicated logic, etc.), computer readable instructions (run on a general purpose computer system or a dedicated machine), or a combination of both. In an illustrative example, method 400 may be performed by supervisor mode manager 125 in FIG. 1, or supervisor mode manager 210 in FIG. 2. Alternatively, some or all of method 400 might be performed by another module or machine. It should be noted that blocks depicted in FIG. 4 could be performed simultaneously or in a different order than that depicted.

At block 405, processing logic processes a request to copy data from an application memory space to an operating system (OS) memory space. In some implementations, processing a request can be performed as described above with respect to the method of FIG. 3. At block 410, processing logic determines whether there are additional requests to be processed. If so, processing returns to block 405. Otherwise, processing continues to block 415.

At block 415, processing logic determines whether terminate monitoring for additional requests. In some implementations, monitoring may be terminated if the monitoring processing device is to be assigned to other tasks (e.g., as described above with respect to FIGS. 1-2). If monitoring not to be terminated, processing continues to block 420 where processing logic updates an execution state of the monitoring processing device to indicate that it is in a low power state and can be subsequently invoked to process new requests when they are received.

If at block 415, processing logic determines that monitoring is to be terminated, processing proceeds to block 425. At block 425, processing logic terminates monitoring for additional requests. At block 430, processing logic disables access to application memory space for the monitoring processing device. In some implementations, access can be disabled by re-enabling SMAP for the processing device. At block 435, processing logic updates the execution state of the monitoring processing device to indicate that it is in a idle power state and can be subsequently invoked to process different tasks.

FIG. 5 depicts an example computer system 500 which can perform any one or more of the methods described herein. In one example, computer system 500 may correspond to computer system 100 of FIG. 1. The computer system may be connected (e.g., networked) to other computer systems in a LAN, an intranet, an extranet, or the Internet. The computer system may operate in the capacity of a server in a client-server network environment. The computer system may be a personal computer (PC), a set-top box (STB), a server, a network router, switch or bridge, or any device capable of executing a set of instructions (sequential or otherwise) that specify actions to be taken by that device. Further, while a single computer system is illustrated, the term “computer” shall also be taken to include any collection of computers that individually or jointly execute a set (or multiple sets) of instructions to perform any one or more of the methods discussed herein.

The exemplary computer system 500 includes a processing device 502, a main memory 504 (e.g., read-only memory (ROM), flash memory, dynamic random access memory (DRAM) such as synchronous DRAM (SDRAM)), a static memory 506 (e.g., flash memory, static random access memory (SRAM)), and a data storage device 516, which communicate with each other via a bus 508.

Processing device 502 represents one or more general-purpose processing devices such as a microprocessor, central processing unit, or the like. More particularly, the processing device 502 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 502 may also be one or more special-purpose processing devices such as an application specific integrated circuit (ASIC), a field programmable gate array (FPGA), a digital signal processor (DSP), network processor, or the like. The processing device 502 is configured to execute processing logic (e.g., instructions 526) that includes supervisor mode manager 125 for performing the operations and steps discussed herein (e.g., corresponding to the method of FIGS. 3-4, etc.).

The computer system 500 may further include a network interface device 522. The computer system 500 also may include a video display unit 510 (e.g., a liquid crystal display (LCD) or a cathode ray tube (CRT)), an alphanumeric input device 512 (e.g., a keyboard), a cursor control device 514 (e.g., a mouse), and a signal generation device 520 (e.g., a speaker). In one illustrative example, the video display unit 510, the alphanumeric input device 512, and the cursor control device 514 may be combined into a single component or device (e.g., an LCD touch screen).

The data storage device 516 may include a non-transitory computer-readable medium 524 on which may store instructions 526 that include supervisor mode manager 125 (e.g., corresponding to the method of FIGS. 3-4, etc.) embodying any one or more of the methodologies or functions described herein. Supervisor mode manager 125 may also reside, completely or at least partially, within the main memory 504 and/or within the processing device 502 during execution thereof by the computer system 500, the main memory 504 and the processing device 502 also constituting computer-readable media. Supervisor mode manager 125 may further be transmitted or received over a network via the network interface device 522.

While the computer-readable storage medium 524 is shown in the illustrative examples to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

Although the operations of the methods herein are shown and described in a particular order, the order of the operations of each method may be altered so that certain operations may be performed in an inverse order or so that certain operation may be performed, at least in part, concurrently with other operations. In certain implementations, instructions or sub-operations of distinct operations may be in an intermittent and/or alternating manner.

It is to be understood that the above description is intended to be illustrative, and not restrictive. Many other implementations will be apparent to those of skill in the art upon reading and understanding the above description. The scope of the disclosure should, therefore, be determined with reference to the appended claims, along with the full scope of equivalents to which such claims are entitled.

In the above description, numerous details are set forth. It will be apparent, however, to one skilled in the art, that aspects of the present disclosure may be practiced without these specific details. In some instances, well-known structures and devices are shown in block diagram form, rather than in detail, in order to avoid obscuring the present disclosure.

Unless specifically stated otherwise, as apparent from the following discussion, it is appreciated that throughout the description, discussions utilizing terms such as “receiving,” “enabling,” “retrieving,” “copying,” “sending,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the specific purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

Aspects of the disclosure presented herein are not inherently related to any particular computer or other apparatus. Various general purpose systems may be used with programs in accordance with the teachings herein, or it may prove convenient to construct more specialized apparatus to perform the specified method steps. The structure for a variety of these systems will appear as set forth in the description below. In addition, aspects of the present disclosure are not described with reference to any particular programming language. It will be appreciated that a variety of programming languages may be used to implement the teachings of the disclosure as described herein.

Aspects of the present disclosure may be provided as a computer program product that may include a machine-readable medium having stored thereon instructions, which may be used to program a computer system (or other electronic devices) to perform a process according to the present disclosure. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.).

The words “example” or “exemplary” are used herein to mean serving as an example, instance, or illustration. Any aspect or design described herein as “example” or “exemplary” is not to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. Furthermore, the terms “first,” “second,” “third,” “fourth,” etc. as used herein are meant as labels to distinguish among different elements and may not have an ordinal meaning according to their numerical designation.

What is claimed is:

1. A method comprising:
receiving, by a first processor, a first notification from an operating system (OS), wherein the first notification instructs the first processor to monitor a data structure for a request to copy data from an application memory space to an OS memory space, wherein the first processor executes with access to the application memory space enabled, and wherein the request to copy the data is associated with a second processor that executes with access to the application memory space disabled;
retrieving an entry from the data structure, wherein the entry comprises a source address associated with the data in the application memory space and a destination address in the OS memory space;
copying the data from the source address in the application memory space to the destination address in the OS memory space; and
responsive to copying the data from the source address to the destination address, sending a second notification to the second processor to cause the second processor to perform an operation on the data at the destination address in the OS memory space, wherein the second processor executes with access to the application memory space disabled.

2. The method of claim 1, further comprising:
monitoring the data structure for an additional request to copy additional data from an additional application memory space to an additional OS memory space;
retrieving an additional entry from the data structure, wherein the additional entry comprises an additional source address associated with the additional data in the additional application memory space and an additional destination address in the additional OS memory space; and
copying the data from the additional source address in the application memory space to the additional destination address in the OS memory space.

3. The method of claim 2, further comprising:
responsive to determining that no additional entries are present in the data structure:
terminating the monitoring of the data structure;
disabling access to the application memory space for the first processor; and
updating an execution state of the first processor to indicate that the first processor is in an idle state.

4. The method of claim 3, further comprising:
receiving a third notification to resume monitoring the data structure for requests to copy data from the application memory space to the OS memory space;
enabling access to the application memory space for the first processor; and
resuming the monitoring of the data structure.

5. The method of claim 2, further comprising:
responsive to determining that no additional entries are present in the data structure, updating an execution state of the first processor to indicate that the first processor is in a low power state.

6. The method of claim 1, wherein receiving the first notification comprises:
detecting an interrupt generated by an operation that writes the entry the data structure.

7. The method of claim 1, wherein sending the second notification to the second processor comprises:
sending an inter-processor interrupt (IPI) to the second processor to cause the second processor to perform the operation on the data.

8. The method of claim 1, wherein the entry in the data structure further comprises a function address associated with the operation to be performed by the second processor, and wherein the second processor is to:
retrieving the entry from the data structure; and
performing the operation in view of the function address associated with the operation.

9. The method of claim 1, wherein the data comprises a networking packet, and wherein performing the operation comprises sending the networking packet to a networking device.

10. A system comprising:
a memory; and
a processing device comprising a plurality of processors, wherein the processing device is operatively coupled to the memory, to:
receive, by a first processor of the plurality of processors, a first indication from an operating system (OS) to monitor a data structure for a request to copy data between an application memory space and an OS memory space, wherein the first processor executes with access to the application memory space enabled, and wherein the request to copy the data is associated with a second processor of the plurality of processor that executes with access to the application memory space disabled;
retrieve an entry from the data structure, wherein the entry comprises a source address associated with the data in the application memory space and a destination address in the OS memory space;
copy the data from the source address in the application memory space to the destination address in the OS memory space; and
responsive to copying the data from the source address to the destination address, send a second indication to the second processor of the plurality of processors to cause the second processor to perform an operation on the data at the destination address in the OS memory space, wherein the second processor executes with access to the application memory space disabled.

11. The system of claim 10, wherein the processing device is further to:
monitor the data structure for an additional request to copy additional data from an additional application memory space to an additional OS memory space;
retrieve an additional entry from the data structure, wherein the additional entry comprises an additional source address associated with the additional data in the additional application memory space and an additional destination address in the additional OS memory space; and
copy the data from the additional source address in the application memory space to the additional destination address in the OS memory space.

12. The system of claim 11, wherein the processing device is further to:
responsive to determining that no additional entries are present in the data structure:
terminate the monitoring of the data structure;
disable access to the application memory space for the first processor; and
update an execution state of the first processor to indicate that the first processor is in an idle state.

13. The system of claim 12, wherein the processing device is further to:
receive a third indication to resume monitoring the data structure for requests to copy data from the application memory space to the OS memory space;
enable access to the application memory space for the first processor; and
resume the monitoring of the data structure.

14. The system of claim 11, wherein the processing device is further to:
responsive to determining that no additional entries are present in the data structure, update an execution state of the first processor to indicate that the first processor is in a low power state.

15. The system of claim 10, wherein to receive the first indication, the processing device is further to:
detect an interrupt generated by an operation that writes the entry the data structure.

16. The system of claim 10, wherein to send the second indication to the second processor, the processing device is further to:
send an inter-processor interrupt (IPI) to the second processor to cause the second processor to perform the operation on the data.

17. A non-transitory computer readable medium comprising instructions, which when accessed by a processing device, cause the processing device to:
receive a first notification from an operating system (OS), wherein the first notification instructs a first processor of a plurality of processors to monitor a data structure for a request to copy data between an application memory space and an OS memory space, wherein the first processor executes with access to the application memory space enabled, and wherein the request to copy the data is associated with a second processor of the plurality of processor that executes with access to the application memory space disabled;
retrieve an entry from the data structure, wherein the entry comprises a source address associated with the data in the application memory space and a destination address in the OS memory space;
copy the data from the source address in the application memory space to the destination address in the OS memory space; and
responsive to copying the data from the source address to the destination address, send an inter-processor interrupt (IPI) to the second processor to cause the second processor to perform an operation on the data at the destination address in the OS memory space, wherein the second processor executes with access to the application memory space disabled.

18. The non-transitory computer readable medium of claim 16, wherein the processing device is further to:
monitor the data structure for an additional request to copy additional data from an additional application memory space to an additional OS memory space;
retrieve an additional entry from the data structure, wherein the additional entry comprises an additional source address associated with the additional data in the additional application memory space and an additional destination address in the additional OS memory space; and
copy the data from the additional source address in the application memory space to the additional destination address in the OS memory space.

19. The non-transitory computer readable medium of claim 17, wherein the processing device is further to:
responsive to determining that no additional entries are present in the data structure:
terminate the monitoring of the data structure;
disable access to the application memory space for the first processor; and
update an execution state of the first processor to indicate that the first processor is in an idle state.

20. The non-transitory computer readable medium of claim 19, wherein the processing device is further to:
receive a third notification to resume monitoring the data structure for requests to copy data from the application memory space to the OS memory space;
enable access to the application memory space for the first processor; and
resume the monitoring of the data structure.
